(19) United States
(12) Patent Application Publication
(10) Pub. No.: US 2025/0369603 A1
(43) Pub. Date: Dec. 4, 2025

(54) Rotary Folding Lamp

(71) Applicant: NINGBO FUTAI ELECTRIC LIMITED, NINGBO (CN)

(72) Inventors: Fujun Qiu, NINGBO (CN); Yuanlong Ye, NINGBO (CN); Guohui Chen, NINGBO (CN)

(21) Appl. No.: 19/277,348

(22) Filed: Jul. 22, 2025

Related U.S. Application Data
(63) Continuation-in-part of application No. 18/676,420, filed on May 28, 2024, now Pat. No. 12,385,632.

(51) Int. Cl. F21V 21/28; F21V 15/01

(52) U.S. Cl. CPC F21V 21/28; F21V 15/01

(57) ABSTRACT

A rotary folding lamp includes a base assembly, a folding mechanism, a control unit and a lamp assembly including a first lamp body, a second lamp body and a third lamp body, wherein the first lamp body is connected between the base assembly and the second lamp body, the third lamp body is arranged at a front end of the second lamp body, the folding mechanism is arranged at both ends of the first lamp body to control folding of the first lamp body and the second lamp body, and the control unit is electrically connected to the lamp assembly.

### CROSS REFERENCE OF RELATED APPLICATION

This application is a Continuation-In-Part application that claims the benefit of priority under 35 U.S.C. § 120 to a non-provisional application, application Ser. No. 18/676,420, filing date May 28, 2024, which is a non-provisional application that claims priority under 35 U.S.C. § 119 to China application number CN202310647964.4, filing date Jun. 2, 2023, and China application number CN202321384644.6, filing date Jun. 2, 2023, wherein the entire content of which is expressly incorporated herein by reference.

### BACKGROUND OF THE PRESENT INVENTION

### Field of Invention

The present invention relates to foldable handheld lamp, and more particularly to a rotary folding lamp.

### Description of Related Arts

With the acceleration of modern life rhythm and the change of lifestyle, night outdoor work, outdoor camping, and outdoor late-night snacks have become very common. However, due to the insufficient brightness and inconvenient lighting outdoors at night, outdoor night lights have become a necessary tool for night outdoor work.

For conventional lamps, some have oversized dimensions, which are inconvenient to carry; some lamps, although meeting the requirements of being small and portable, have a single lighting angle and limited lighting range, which cannot meet the needs of users; some lamps, although achieving the corresponding brightness, cannot meet the needs of multi-occasion applications. Therefore, there is an urgent need for a compact and portable lamp that can provide all-round lighting and adjust the lighting angle and range according to the needs, so as to meet the users' various needs.

### SUMMARY OF THE PRESENT INVENTION

An advantage of the present invention is to provide a rotary folding lamp, wherein the rotary folding lamp can present multi-angle illumination through rotation, and has a larger illumination range, so that it is suitable for multiple occasions.

Another advantage of the present invention is to provide a rotary folding lamp, wherein the rotary folding lamp can be folded multiple times, and the folded volume is small and easy to carry.

Another advantage of the present invention is to provide a rotary folding lamp, wherein the rotary folding lamp is suitable for bidirectional folding, achieving a folding angle of 360°, making the folding operation simpler, and can be fixed at any angle and provide a larger range of angle control.

Another advantage of the present invention is to provide a rotary folding lamp, wherein the rotary folding lamp comprises multiple light emitting parts, and the multiple light emitting parts have multiple lighting modes, and different light emitting parts can be activated according to the different folding and unfolding states, thus having multiple lighting modes and multiple lighting ranges, which can meet the various application needs of different users.

Another advantage of the present invention is to provide a rotary folding lamp, wherein the rotary folding lamp can be fixed in various ways such as hanging, sticking, adsorbing, handheld, and standing plane, and the user can choose according to their needs.

Another advantage of the present invention is to provide a rotary folding lamp, wherein the rotary folding lamp can be manually rotated and folded, or automatically rotated and folded, and the folding state and the unfolding state can be switched arbitrarily with simple operation.

Another advantage of the present invention is to provide a rotary folding lamp, wherein the rotary folding lamp is rechargeable and suitable for outdoor applications.

Another advantage of the present invention is to provide a rotary folding lamp with multiple folding parts and rotating parts, which can be fixed at any angle within the folding angle and rotating angle range of each part for use. Therefore, it can achieve lighting in a certain direction as well as all-round lighting.

According to one aspect, the present invention provides a rotary folding lamp comprising:
a support assembly;
a light emitting assembly, wherein the light emitting assembly comprises a first light emitting part and a second light emitting part which is foldably connected to the first light emitting part;
a rotation assembly arranged between the first light emitting part and the support assembly to allow the first light emitting part to rotate with respect to the support assembly;
a folding assembly arranged between the support assembly and the rotation assembly to allow the first light emitting part to be folded onto the support assembly; and
a control component arranged on the support assembly and electrically connected to the light emitting assembly.

According to an embodiment, the folding assembly comprises a first folding element, a second folding element, and a third folding element, which are respectively provided on the support assembly, the first light emitting part, and the second light emitting part, wherein the third folding element is configured to be movable around the second folding element.

According to an embodiment, the rotation assembly comprises a first rotating element and a second rotating element, wherein the first rotating element is rotatably connected to the first folding element, and the second rotating element is connected to the first light emitting part, wherein the second rotating element is rotatably connected to the first rotating element.

According to an embodiment, the light emitting assembly further comprises a third light emitting part which is provided on a top of the support assembly adjacent to the first folding element.

According to an embodiment, the first light emitting part comprises a first light source and a first attaching surface, the second light emitting part comprises a second light source and a second attaching surface, the first light source is provided at a side of the first attaching surface, and the second light source is provided at a side of the second attaching surface, after folding, the first attaching surface is attached with the second attaching surface, and is capable of being aligned in a same straight line with the support assembly.

According to an embodiment, the second light emitting part further comprises a third light source, and the second light source and the third light source are respectively installed on two sides of the second attaching surface.

According to an embodiment, the folding assembly comprises a first folding element, a second folding element, a third folding element, and a folding connecting element, wherein the first folding element is positioned between the support assembly and the first light emitting part, the folding connecting element is rotatably connected between the second folding element and the third folding element, the second folding element and the third folding element are respectively positioned between the first light emitting part and the second light emitting part, wherein the second light emitting part is capable of folding in two directions towards the first light emitting part and is capable of being fixed at any folding angle between 0° and 360°.

According to an embodiment, the support assembly comprises an installation housing, a power supply component, and has an installation cavity and a storage cavity, wherein the installation cavity is formed inside the installation housing, and the power supply component is installed in the installation cavity, the storage cavity is formed as a side of the installation housing to accommodate the first light emitting part and the second light emitting part in a folded state.

According to an embodiment, the control component comprises a control switch, a light emitting adjusting component, and a circuit module, the circuit module is electrically connected to the light emitting assembly, the power supply component, the light emitting adjusting component, and the control switch, and the circuit module is installed in the installation cavity, the control switch and the light emitting adjusting component are positioned at an outside of the installation housing.

According to an embodiment, the control component further comprises a rotation control component and a folding control component, wherein the rotation control component and the folding control component are arranged on an outside of the housing and are electrically connected to the circuit module, the rotation assembly is operatively controlled by the rotation control component, and the folding assembly is operatively controlled by the folding control component.

According to an embodiment, the support assembly further comprises a first fixing part, a second fixing part, and a third fixing part, all of which are arranged at a bottom of the installation housing.

According to another aspect, the present invention provides a rotary folding lamp, comprising:
a support assembly;
a light emitting assembly, wherein the light emitting assembly comprises a first light emitting part, a second light emitting part, and a third light emitting part, wherein the second light emitting part is foldable and rotatably connected to the first light emitting part, and the third light emitting part is arranged on a top of the support assembly;
a rotation assembly arranged at two ends of the first light emitting part, and through the rotation assembly, the first light emitting part is capable of rotating with respect to the support assembly and the second light emitting part;
a folding assembly connected to the rotation assembly, and through the folding assembly, the first light emitting part and the second light emitting part are capable of switching between a folded state and an unfolded state; and
a control component provided on the support assembly and electrically connected to the light emitting assembly.

According to an embodiment, the folding assembly comprises a first rotating folding member and a second rotating folding member, wherein the first rotating folding member is provided at a top of the support assembly to enabling a folding between the first light emitting part and the support assembly, wherein the second rotating folding member is provided at a top of the first light emitting part to enable a folding between the second light emitting part and the first light emitting part.

According to an embodiment, the rotation assembly comprises a first rotating element, a second rotating element, a third rotating element, and a fourth rotating element, the first rotating element is rotatably connected to the first rotating folding member, the second rotating element is positioned at a bottom of the first light emitting part and is rotatably connected to the first rotating element for driving the first light emitting part to rotate around the support assembly, wherein during movement of the first rotating element around the first rotating folding member, the first light emitting part is driven to be folded or unfolded with respect to the support assembly, wherein the third rotating element is rotatably connected to the second rotating folding member, the fourth rotating element is positioned at a bottom of the second light emitting part and is rotatably connected to the third rotating element for driving the second light emitting part to rotate around the first light emitting part, wherein during movement of the third rotating element around the second rotating folding member, the second light emitting part is driven to be folded or unfolded with respect to the first light emitting part.

According to an embodiment, the control component comprises a control switch, a light emitting adjusting component, a circuit module, a rotation control component, and a folding control component, wherein the circuit module is electrically connected to the control switch, the light emitting adjusting component, and the light emitting assembly, wherein the rotation control component is electrically connected to the circuit module for operatively driving the rotation assembly to control rotation of the light emitting assembly within an angle range of 0°-360°, wherein the folding control component is electrically connected to the circuit module for driving the folding assembly to control folding of the light emitting assembly.

According to an embodiment, the support assembly comprises an installation housing, a handheld part, a first fixing part, a second fixing part, a third fixing part, an electrical connection terminal, and a power supply component, wherein the handheld part is installed on an outer side of the installation housing, the first fixing part, the second fixing part, and the third fixing part are all located at a bottom of the installation housing, the power supply component is installed inside the installation housing and is electrically connected to the control component and the electrical connection terminal, the electrical connection terminal is provided on the installation housing.

Another advantage of the present invention is to provide a multi-directional lighting fixture which can realize multi-directional lighting, has a large lighting range, and is suitable for various occasions.

Another advantage of the present invention is to provide a multi-directional lighting fixture which is provided with a plurality of lamp bodies. The plurality of lamp bodies can be rotated and folded, and can be fixed at any angle, so that the angle control range is larger.

Another advantage of the present invention is to provide a multi-directional lighting fixture which can achieve longitudinal and lateral lighting and has a large lighting range.

Another advantage of the present invention is to provide a multi-directional lighting fixture which is provided with a display screen that can display information such as power level, lighting mode, folding angle, etc. in real time, thereby achieving a smarter and more convenient interactive experience.

Another advantage of the present invention is to provide a multi-directional lighting fixture which can be folded multiple times and has a small size after being folded, making it easy to carry.

Another advantage of the present invention is to provide a multi-directional lighting fixture which is provided with multiple lamp bodies, has multiple lighting modes, and can activate different lighting modes according to different folding and unfolding states, thereby meeting various application needs of different users.

Another advantage of the present invention is to provide a multi-directional lighting fixture which has a variety of fixing methods and the user can choose according to needs.

According to another aspect, the present invention provides a multi-directional lighting fixture which is a rotary folding lamp including a base assembly, a folding mechanism, a control unit and a lamp assembly including a first lamp body, a second lamp body and a third lamp body, wherein the first lamp body is connected between the base assembly and the second lamp body, the third lamp body is arranged at a front end of the second lamp body, the folding mechanism is arranged at both ends of the first lamp body to control folding of the first lamp body and the second lamp body, and the control unit is electrically connected to the lamp assembly.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a rotary folding lamp according to a first preferred embodiment of the present invention.

FIG. 2 is another perspective view of the rotary folding lamp according to the above-mentioned first preferred embodiment of the present invention.

FIG. 3 is an exploded view of the rotary folding lamp according to the above first preferred embodiment of the present invention.

FIG. 4 is a schematic view illustrating a first working state of the rotary folding lamp according to the above preferred embodiment of the present invention.

FIG. 5 is another schematic view illustrating a second working state of the rotary folding lamp according to the above first preferred embodiment of the present invention.

FIG. 6 is another schematic view illustrating a third working state of the rotary folding lamp according to the above first preferred embodiment of the present invention.

FIG. 7 is another schematic view illustrating a fourth working state of the rotary folding lamp according to the above first preferred embodiment of the present invention.

FIG. 8 is a perspective view illustrating a working state of the rotary folding lamp according to a second preferred embodiment of the present invention.

FIG. 9 is a perspective view illustrating the rotary folding lamp according to a third preferred embodiment of the present invention.

FIG. 10 is another perspective view of the rotary folding lamp according to the above third preferred embodiment of the present invention.

FIG. 11 is a perspective view of a rotary folding lamp according to a fourth preferred embodiment of the present invention.

FIG. 12 is a perspective view of a rotary folding lamp according to a fifth preferred embodiment of the present invention.

FIG. 13 is a perspective view of a rotary folding lamp according to a sixth preferred embodiment of the present invention.

FIGS. 14, 15 and 16 are perspective views of the rotary folding lamp in different working states according to the above sixth preferred embodiment of the present invention.

FIG. 17 is a perspective views of the rotary folding lamp according to the above sixth preferred embodiment of the present invention.

FIG. 18 is a schematic view of a multi-directional lighting fixture according to a seventh embodiment of the present invention.

FIG. 19A is one of the exploded view of the multi-directional lighting fixture according to the above seventh embodiment of the present invention.

FIG. 19B is a second exploded view of the multi-directional lighting fixture according to the above seventh embodiment of the present invention.

FIG. 19C is a third exploded view of the multi-directional lighting fixture according to the above seventh embodiment of the present invention.

FIG. 20 is a schematic view of a folding mechanism of the multi-directional lighting fixture according to the above seventh embodiment of the present invention.

FIG. 21 is a schematic view showing a first lamp body and a second lamp body of the multi-directional lighting fixture according to the above seventh embodiment of the present invention in a closed state.

FIG. 22 is a schematic view of the multi-directional lighting fixture according to the above seventh embodiment of the present invention, in which the first lamp body is in an extended state and the second lamp body is in a closed state.

FIG. 23 is a schematic view of the first lamp body and the second lamp body of the multi-directional lighting fixture according to the above seventh embodiment of the present invention in an unfolded state.

FIG. 24 is a schematic view of a maximum unfolded state of the multi-directional lighting fixture according to the above seventh embodiment of the present invention.

FIG. 25 is a schematic view of another implementation of the multi-directional lighting fixture according to the above seventh embodiment of the present invention.

FIG. 26 is a schematic view of another implementation of the multi-directional lighting fixture according to the above seventh embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back,” “left,” “right,” “perpendicular,” “horizontal,” “top,” “bottom,” “inner,” “outer,” and etc. that indicate relations of directions or positions are based on the relations of directions or positions shown in the appended drawings, which are only to facilitate descriptions of the present invention and to simplify the descriptions, rather than to indicate or imply that the referred device or element is limited to the specific direction or to be operated or configured in the specific direction. Therefore, the above-mentioned terminologies shall not be interpreted as confine to the present invention.

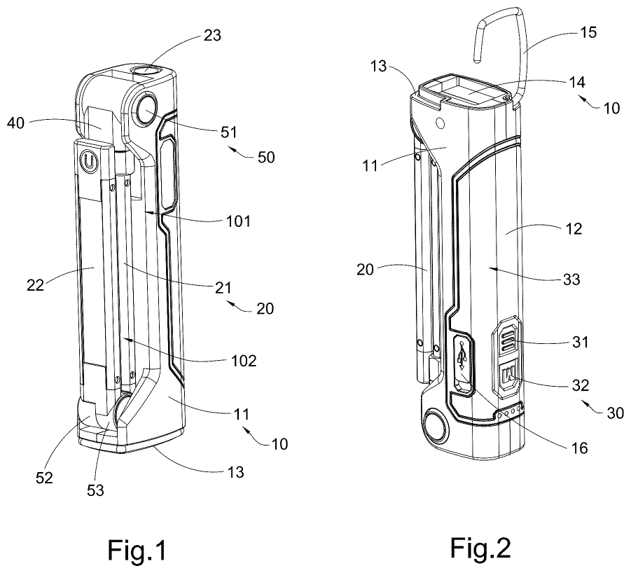

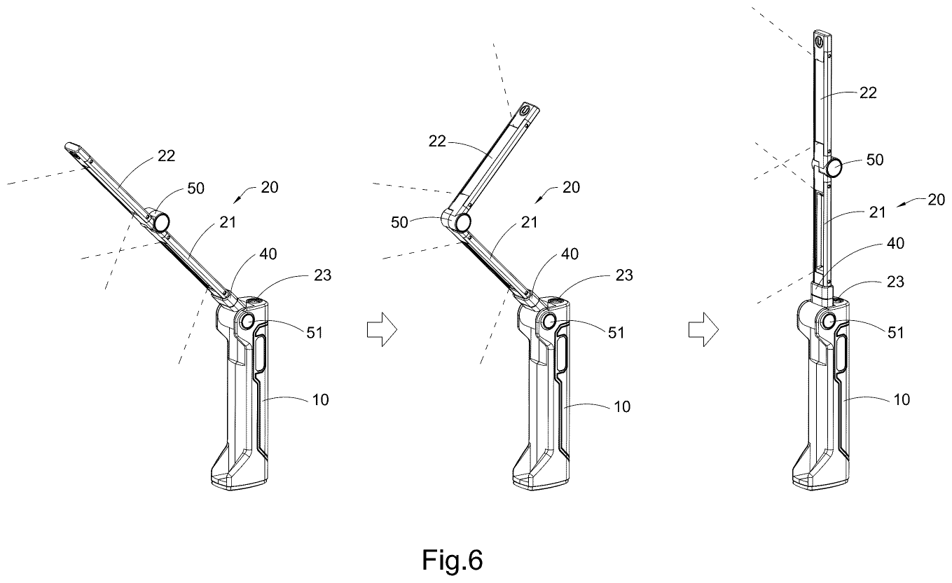

Referring to FIGS. 1 to 7 of the drawings, a rotary folding lamp according to a first preferred embodiment of the present invention is illustrated. In this embodiment, the rotary folding lamp comprises a support assembly 10, a light emitting assembly 20, a control component 30, a rotation assembly 40, and a folding assembly 50. The light emitting assembly 20 is installed on the top of the support assembly 10, the control component 30 is provided on the support assembly 10 and is used to control the light emitting assembly 20. The rotation assembly 40 is connected between the support assembly 10 and the light emitting assembly 20 for achieving the rotation of the light emitting assembly 20 with respect to the support assembly 10. The folding assembly 50 is connected to the light emitting assembly 20, and the folding and unfolding process of the light emitting assembly 20 is completed through the folding assembly 50.

The support assembly 10 comprises an installation housing 11, a handheld part 12, and a first fixing part 13. The handheld part 12 is located on a side of the installation housing 11 and is suitable for the user to hold. The first fixing part 13 is located at a bottom of the installation housing 11 for allowing the support assembly 10 and the light emitting assembly 20 connected to a top of the support assembly 10 to stand on a plane, so as to free the user's hands and meet the user's needs.

The handheld part 12 adopts ergonomic design to provide a more comfortable grip for the user. The handheld part 12 also has an anti-slip function for ensuring a firmer grip. The handheld part 12 can be made of anti-slip material or achieve anti-slip function by setting rounded anti-slip protrusions and grooves, etc.

The support assembly 10 further comprises a second fixing part 14 which is disposed on the first fixing part 13. The second fixing part 14 is implemented as a magnet for fixing the rotary folding lamp to a surface of an object through magnetic attraction, so as to free the user's hands.

After the second fixing part 14 is set at the bottom of the first fixing part 13, the bottom surface of the first fixing part 13 provides a flat surface by the second fixing part 14, and the first fixing part 13 can still stand on a plane. When standing on a magnetic object surface, the second fixing part 14 assists the first fixing part 13 through magnetic attraction, making the fixation more secure. In addition, the magnetic attraction of the second fixing part 14 allows the rotary folding lamp to be fixed at different angles on a magnetic object surface, so as to meet the user's different needs.

The support assembly 10 further comprises a third fixing part 15 which is also set on the first fixing part 13. The third fixing part 15 is implemented as a suspension component which allows the rotary folding lamp to be suspended on an object through the third fixing part 15, making it convenient for the user to carry and preventing loss. It also facilitates the fixation of the lamp when the user is unable to hold it conveniently.

The first fixing part 13 has a cavity that can accommodate the suspension component of the third fixing part 15, so that the third fixing part 15 can be stored inside the first fixing part 13 when not in use, and the bottom of the first fixing part 13 remains flat and can stand on a plane.

The support assembly 10 further comprises an electrical connection terminal 16 and a power supply component 17. The power supply component 17 is electrically connected to the electrical connection terminal 16 and the light emitting assembly 20. The electrical connection terminal 16 is set in the installation housing 11 and is connected to a power source to charge the power supply component 17 and provides power to the light emitting assembly 20.

In addition, it will be understood by those skilled in the art that, apart from this embodiment, under the concept of the present invention, the rotary folding lamp can also be directly powered by connecting the power source to the electrical connection terminal 16.

The support assembly 10 has an installation cavity 101 which is defined inside the installation housing 11, and the power supply component 16 is installed in the installation cavity 101.

The support assembly 10 also has a storage cavity 102 which is formed at a side of the installation housing 11 and matches the shape and size of the light emitting assembly 20. The storage cavity 102 is used to accommodate the light emitting assembly 20, so that after the light emitting assembly 20 is accommodated, it is flush with the periphery of the installation housing 11, making the folded rotating lamp smaller in volume and aesthetically pleasing.

It is worth mentioning that the inside of the storage cavity 102 has a scratch-resistant function which can protect the light emitting assembly 20 and extend its service life. Therefore, the inside of the storage cavity 102 can be designed with rounded protrusions and grooves to support the light emitting assembly 20, or it can be made of soft materials to prevent damage to the light emitting assembly 20 caused by rigid design.

The light emitting assembly 20 comprises at least two light emitting parts. In this embodiment, the light emitting parts comprises a first light emitting part 21, a second light emitting part 22, and a third light emitting part 23. One end of the first light emitting part 21 is connected to the rotation assembly 40, the rotation assembly 40 is connected to the top of the support assembly 10 through the folding assembly 50. The second light emitting part 22 is foldably connected to the other end of the first light emitting part 21. The third light emitting part 23 is set on the top of the installation housing 11 adjacent to the rotation assembly 40.

In this embodiment, the light emitting assembly 20 comprises two foldable light emitting parts, namely the first light emitting part 21 and the second light emitting part 22, both of which are elongated light emitting strips. The volume is reduced by folding twice through the folding assembly 50. It will be understood by those skilled in the art that the light emitting assembly 20 can also achieve multiple folds by setting more light emitting parts to meet more requirements under stable conditions. In addition, the first light emitting part 21 and the second light emitting part 22 can also be set to other shapes, and are not limited by this embodiment.

The control component 30 comprises a control switch 31 which is disposed in the installation housing 11 and electrically connected to the power supply component 17, the first light emitting part 21, the second light emitting part 22, and the third light emitting part 23. The user controls the illumination of the light emitting assembly 20 by operating the control switch 31.

In this embodiment, the control switch 31 is programmed to comprise different controlling modes. By operating the control switch 31 at different modes, the control switch 31 can selectively control one, two, or three of the first light emitting part 21, the second light emitting part 22, and the third light emitting part 23 to be opened or closed individually or simultaneously.

The control component 30 further comprises a light emitting adjusting component 32 which is electrically connected to the light emitting assembly 20 to regulate the brightness of the light emitting assembly 20. For example, by controlling the number of times the light emitting adjusting component 32 being pressed, the light emitting assembly 20 can switch between strong light, medium light, weak light, daylight, red light, blue light, etc., and the lighting can switch between high brightness, low brightness, and various modes to meet the different needs of the user.

Those skilled in the art will understand that the above-mentioned different lights are just examples. Under the concept of the present invention, the light emitting assembly 20 can have different illumination to meet the lighting needs of the user for various outdoor activities such as work, repair, camping, exploration, fishing, as well as for various leisure activities. It can also meet the needs of users for occasions such as birthday parties and entertainment by setting colored lights.

In this embodiment, the rotation and folding of the light emitting assembly 20 are manually controlled, and the user can change its rotation angle and folding angle by applying an external force to the light emitting assembly 20. In other embodiments of the present invention, the rotation and folding of the light emitting assembly 20 are automatically controlled by a switch. In another embodiment, the light emitting assembly 20 switches between different light emitting modes of different light emitting portions during the folding and rotation process.

The control component 30 further comprises a circuit module 33 which is disposed within the installation housing 11 in the installation cavity 101 and is electrically connected to the first light emitting part 21, the second light emitting part 22, the third light emitting part 23, the power supply component 17, the control switch 31, and the light emitting adjusting component 32. The circuit module 33 is operated by operating the control switch 31 and the light emitting adjusting component 32. In addition, the control component 30 may also include a battery display section, etc.

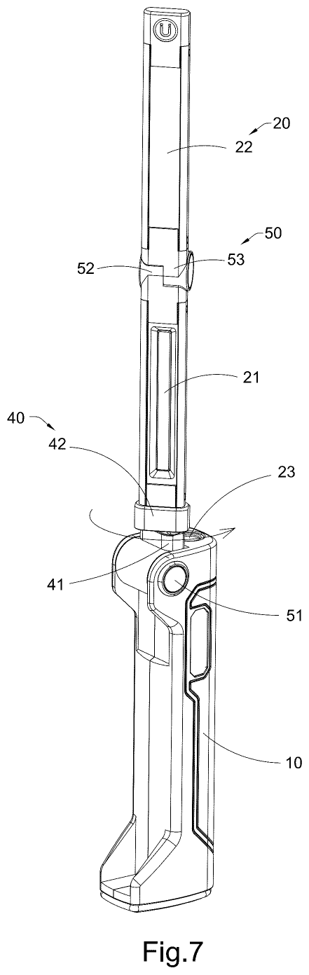

Referring to FIG. 7, the rotation assembly 40 comprises a first rotating element 41 and a second rotating element 42. One end of the second rotating element 42 is rotatably connected to the first rotating element 41, and the other end of the second rotating element 42 is connected to a bottom end of the first light emitting part 21. The rotation between the second rotating element 42 and the first rotating element 41 allows the first light emitting part 21 to rotate 360° around the support assembly 10, and the second light emitting part 22 rotates correspondingly with the rotation of the first light emitting part 21.

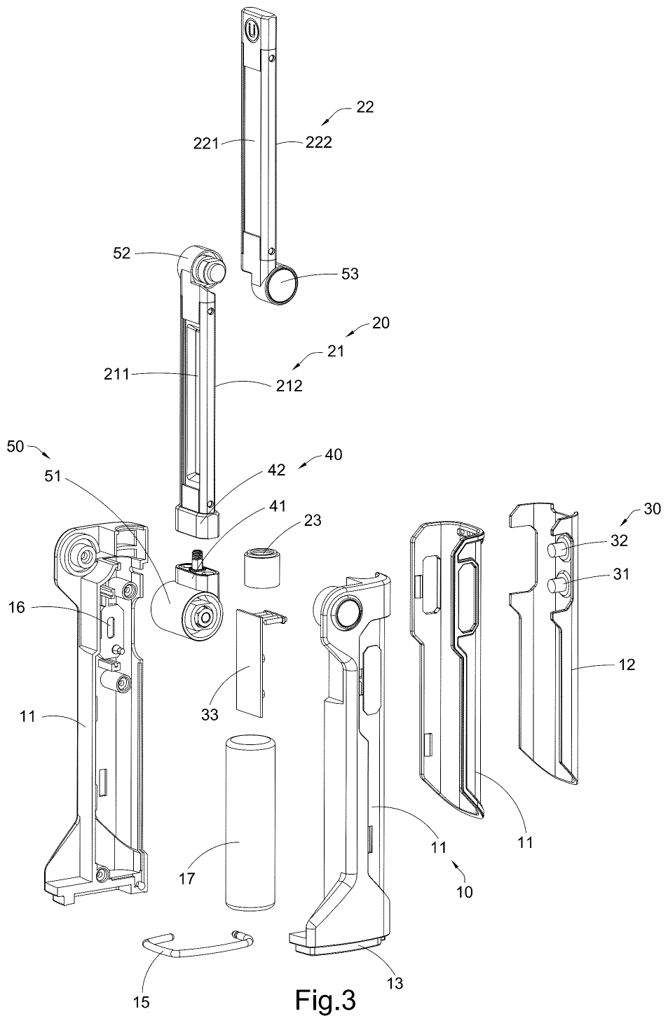

Referring to FIGS. 3 to 6, the folding assembly 50 comprises a first folding element 51 which is connected and fixed to the top of the installation housing 11. The first rotating element 41 is connected to the first folding element 51 and can rotate around the first folding element 51. By applying an external force to the first rotating element 41, the first rotating element 41 can move around the first folding element 51, thereby folding the light emitting assembly 20 and storing it in the storage cavity 102, so as to achieve a first folding of the light emitting assembly 20.

The folding assembly 50 further comprises a second folding element 52 and a third folding element 53. The third folding element 53 is rotatably connected to the second folding element 52, the second folding element 52 is connected to the top of the first light emitting part 21, and the third folding element 53 is connected to the bottom of the second light emitting part 22. During the rotation around the second folding element 52, the third folding element 53 drives the second light emitting part 22 to rotate, causing the second light emitting part 22 to fold with the first light emitting part 21, and both of them are folded in a straight line. In other words, through the second folding element 52 and the third folding element 53, the light emitting assembly 20 achieves secondary folding, and then it is accommodated in the storage cavity 102, resulting in a smaller volume of the entire rotary folding lamp.

It is worth mentioning that the first light emitting part 21 and the support assembly 10 achieve a first folding between them, and the second light emitting part 22 achieves a second folding with the first light emitting part 21, the folding angles are all 0°-180°. The first light emitting part 21 rotates around the support assembly 10 with a rotation angle of 0°-360°, and can stay at any angle within this folding angle and rotation angle range to achieve multi-angle illumination, which can be adjusted in real time according to actual usage requirements.

Those skilled in the art will understand that in this embodiment, the specific structures of the first folding element 51, the second folding element 52, and the third folding element 53 in the drawings are provided as examples. Under the concept of the present invention, the first folding element 51, the second folding element 52, and the third folding element 53 can also be implemented as threaded connections, rotating shafts and slot matching connections, and other structures of pin and hole connections, all of which are within the scope of the present invention.

In this embodiment, the first light emitting part 21 and the second light emitting part 22 are both strip-shaped and have only one light source each, namely, the first light emitting part 21 and the second light emitting part 22 both emit light from one side. When the first light emitting part 21 is folded with the second light emitting part 22, the side surfaces of the first light emitting part 21 and the second light emitting part 22 without light sources are abutted and adhered to each other, so that it is advantageous for protecting the light source surface.

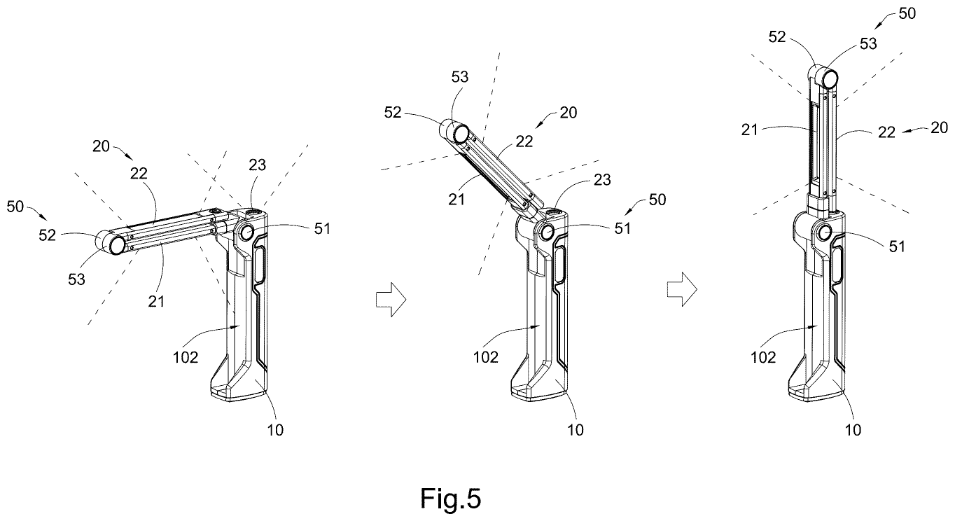

Specifically, referring to FIG. 5, the first light emitting part 21 comprises a first light source 211 and a first attaching surface 212, and the second light emitting part 22 comprises a second light source 221 and a second attaching surface 222. The first light source 211 is positioned on a side surface of the first attaching surface 212, and the second light source 221 is positioned on a side surface of the second attaching surface 222. After folding, the attaching surfaces of the first attaching surface 212 and the second attaching surface 222 without light sources are in contact, forming a separable coupling manner between the first light emitting part 21 and the second light emitting part 22, and the first light source 211 and the second light source 221 are located in two directions facing outward. Therefore, even after folding the first light emitting part 21 and the second light emitting part 22, illumination in two directions can still be achieved.

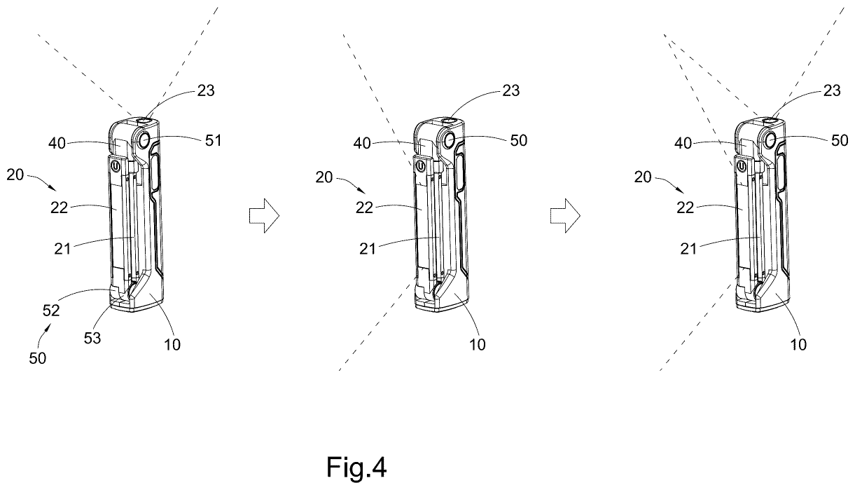

Referring to FIG. 4, when the first light emitting part 21 and the second light emitting part 22 needs to be folded into the storage cavity 102, the first light source 211 faces the inside of the storage cavity 102, and the second light source 221 faces the outside of the storage cavity 102. At this time, the folding lamp is in its minimum volume. According to the user's needs, the user can adjust the control switch 31 to turn on the second light emitting part 22 to emit light, while turn off the first light emitting part 21 which is stored inside the storage cavity 102.

At this time, the third light emitting part 23 is illuminated alone, or the second light emitting part 22 is illuminated alone, or the third light emitting part 23 and the second light emitting part 22 are illuminated simultaneously. In this case, the first light emitting part 21 on the inner side does not emit light, which can save power on one hand and meet the demand for multi-angle illumination on the other hand. Moreover, it can prevent dangerous situations caused by the light emitted from the inner side light source.

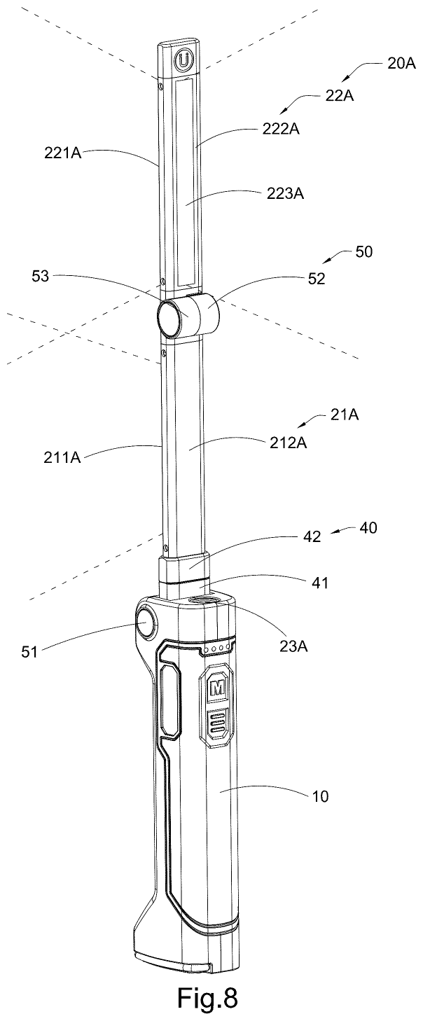

Referring to FIG. 8, a rotary folding lamp according to a second preferred embodiment of the present invention is shown. In this embodiment, improvements are made to the light emitting assembly 20A.

In this embodiment, the light emitting assembly 20A comprises a first light emitting part 21A, a second light emitting part 22A, and a third light emitting part 23A. The first light emitting part 21A comprises a first light source 211A and a first attaching surface 212A, wherein the first light source 211A is located on one side of the first attaching surface 212A.

Compared with the second light emitting part 22 in the first embodiment, the second light emitting part 22A in this embodiment comprises a second light source 221A, a second attaching surface 222A, and a third light source 223A. The second light source 221A and the third light source 223A are respectively located on two sides of the second attaching surface 222A, so that both sides of the second light emitting part 22A can emit light.

When the second light emitting part 22A and the first light emitting part 21A are both in the unfolded state, the first light emitting part 21A emits light from one side, and the second light emitting part 22A emits light from two sides. According to different tilt angles, the rotary folding lamp can present different lighting angles and have a larger lighting range.

Those skilled in the art will understand that the two sides of the first light emitting part 21A can also be equipped with two light sources to achieve a larger lighting range.

In addition to the above embodiments, a fourth light source can be set at the top of the second attaching surface 222A, so that when the second light emitting part 22A is inclined at an angle with the support assembly 20A, the fourth light source can illuminate a farther place, allowing the three light sources of the second light emitting part to present illumination at three different angles. In combination with the first light source and the two illumination directions of the third light emitting part, the rotary folding lamp has a larger illumination range, can achieve all-round illumination, is easy to carry, and is suitable for nighttime outdoor operations.

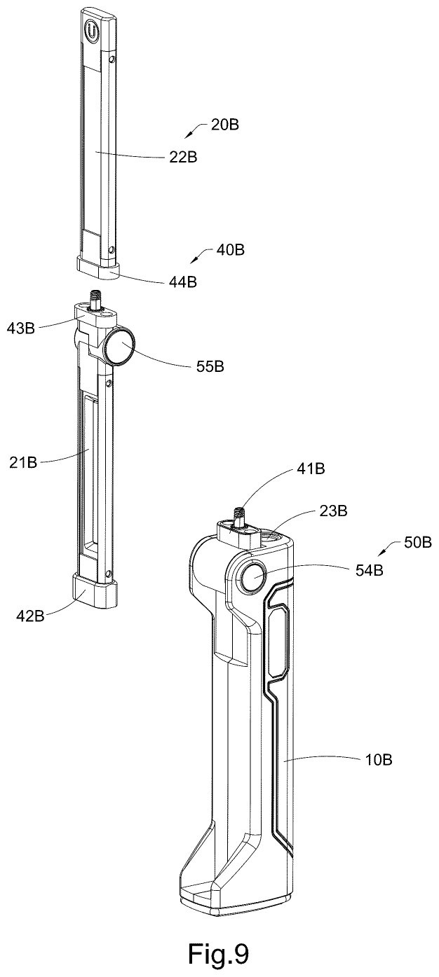

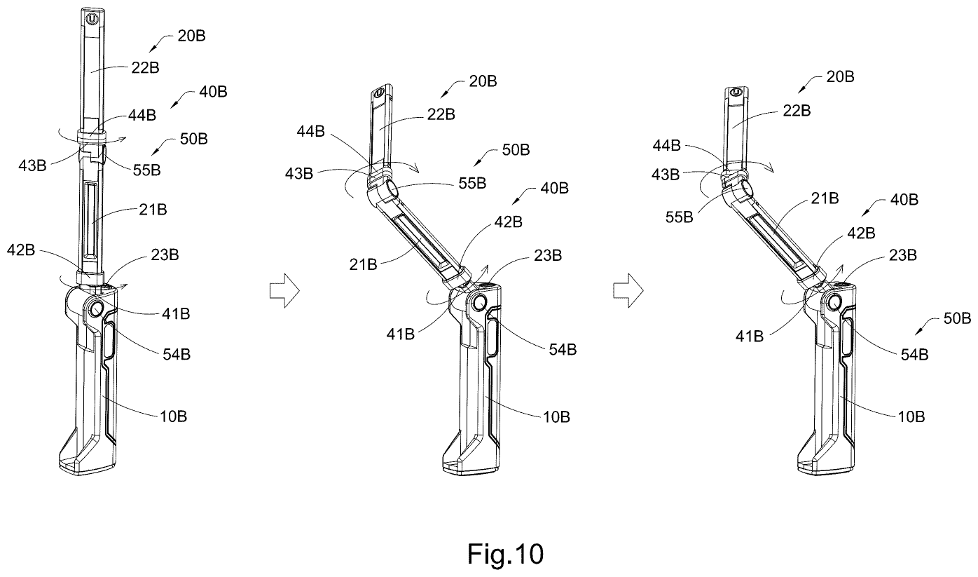

Referring to FIGS. 9 and 10, a rotary folding lamp according to a third preferred embodiment of the present invention is shown. In this embodiment, the rotary folding lamp comprises a support assembly 10B, a light emitting assembly 20B, a control component 30B, a rotation assembly 40B, and a folding assembly 50B. The light emitting assembly 20B is connected to the support assembly 10B, the control component 30B is set on the support assembly 10B to control the operation of the light emitting assembly 20B, and the rotation assembly 40B and the folding assembly 50B control the rotation and folding of the light emitting assembly 20B.

The support assembly 10B and the control component 30B are the same as the support assembly 10 and the control component 30 in the above embodiments, and are not described again here.

The light emitting assembly 20B comprises a first light emitting part 21B, a second light emitting part 22B, and a third light emitting part 23B. The first light emitting part 21B is foldable and rotatably connected between the second light emitting part 22B and the support assembly 10B. The third light emitting part 23B is positioned at the top of the support assembly 10B, adjacent to the bottom of the first light emitting part 21B.

In this embodiment, the folding assembly 50B comprises a first rotating folding member 54B and a second rotating folding member 55B, the first rotating folding member 54B is positioned at the top of the support assembly 10B and adjacent to the third light emitting part 23B. The second rotating folding member 55B is positioned at the top of the first light emitting part 21B.

The rotation assembly 40B comprises a first rotating element 41B, a second rotating element 42B, a third rotating element 43B, and a fourth rotating element 44B, wherein the first rotating element 41B and the second rotating element 42B are positioned between the support assembly 10B and the first light emitting part 21B, allowing the first light emitting part 21B to rotate 360° with respect to the support assembly 10B. The third rotating element 43B and the fourth rotating element 44B are positioned between the top of the first light emitting part 21B and the bottom of the second light emitting part 22B, allowing the second light emitting part 22B to rotate 360° with respect to the first light emitting part 21B.

Specifically, the first rotating element 41B is connected to the top of the support assembly 10B, and the first rotating element 41B is connected to the first rotating folding member 54B and moves around the first rotating folding member 54B. One end of the second rotating element 42B is connected to the bottom of the first light emitting part 21B, and the other end of the second rotating element 42B is rotatably connected to the first rotating element 41B, thereby driving the first light emitting part 21B to rotate and fold with respect to the support assembly 10B.

The third rotating element 43B is connected to a second rotating folding member 55B and can move around the second rotating folding member 55B. One end of the fourth rotating element 44B is connected to the bottom of the second light emitting part 22B, and the other end of the fourth rotating folding assembly 44B is rotatably connected to the third rotating element 43B, thereby driving the second light emitting part 22B to rotate 360° around the first light emitting part 21B, and through the folding motion of the second rotating folding member 55B around the third rotating element 43B, the second light emitting part 22B can be folded onto the first light emitting part 21B, and after folding, the first light emitting part 21B and the second light emitting part 22B are aligned in a straight line.

In this embodiment, the first light emitting part 21B and the second light emitting part 22B can rotate 360° with respect to the support assembly 10B. The second light emitting part 22B can rotate 360° with respect to the first light emitting part 21B. Therefore, the rotary folding lamp in this embodiment has a larger lighting range, and by changing the rotation angle, the lighting direction of different light emitting parts can be changed to meet the different needs of the user.

In other words, the user can change the angle between the first light emitting part 21B and the support assembly 10B between 0° and 180° as needed, and change the angle between the second light emitting part 22B and the first light emitting part 21B between 0° and 180°, thereby obtaining different illumination ranges. At the same time, users can freely rotate the first light emitting part 21B and the second light emitting part 22B between 0° and 360°, so that the first light emitting part 21B can rotate 360° around the support assembly 10B, and the second light emitting part 22B can rotate 360° around the first light emitting part 21B. By rotating and folding at different angles, the lighting direction and lighting range of the first light emitting part 21B and the second light emitting part 22B can be changed, and lighting at any angle and any range can be obtained to meet more needs of the user.

In addition, the second light emitting part 22B is folded over the first light emitting part 21B, and the first light emitting part 21B is further folded over the support assembly 10B. After folding, the second light emitting part 22B, the first light emitting part 21B, and the support assembly 10B are in the same straight line, making the volume of the rotary folding lamp smaller and easier to carry.

In the above three embodiments of the present invention, the user manually folds and rotates, with a folding angle of 0°-180° and a rotating angle of 0°-360°. In other words, within this range, the lamp can stay at any angle as needed.

It is worth mentioning that in the present invention, through the design of the circuit module 33, the first light emitting part 21B and the second light emitting part 22B can be illuminated or turned off automatically during the rotation and folding process, without the need for manual operation by the user.

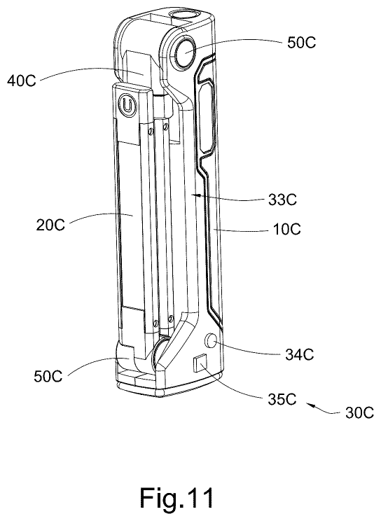

Referring to FIG. 11, a rotary folding lamp according to a fourth preferred embodiment of the present invention is illustrated. In this embodiment, the above embodiments are improved so that the rotary folding lamp can rotate and fold automatically through a switch.

In this embodiment, the rotary folding lamp comprises a support assembly 10C, a light emitting assembly 20C, a control component 30C, a rotation assembly 40C, and a folding assembly 50C. The light emitting assembly 20C is connected to the support assembly 10C, and the rotation assembly 40C is connected between the light emitting assembly 20C and the support assembly 10C, allowing the light emitting assembly 20C to rotate around the support assembly 10C. The folding assembly 50C is positioned between the light emitting assembly 20C and the support assembly 10C, allowing the light emitting assembly 20C to fold with respect to the support assembly 10C.

Unlike the above first preferred embodiment, in this embodiment, the control component 30C is modified. In this embodiment, the control component 30C comprises a circuit module 33C, a rotation control component 34C, and a folding control component 35C, all of which are positioned on the support assembly 10B. The circuit module 33C is positioned inside the support assembly 10B and is electrically connected to the light emitting assembly 20C, the rotation assembly 40C, and the folding assembly 50C. The circuit module 33C is further connected to the rotation control component 34C and the folding control component 35C.

By manipulating the rotation control component 34C and the folding control component 35C, the user controls the rotation angle and folding angle of the light emitting assembly 20C through the circuit module 33C. By changing the pressing force of the rotation control component 34C and the folding control component 35C, the rotation angle and folding angle of the light emitting assembly 20C can be changed, thereby controlling the position of the light emitting assembly 20C with respect to the support assembly 10C, and thus changing the lighting range of the rotating folding luminaire to meet the different needs of different users.

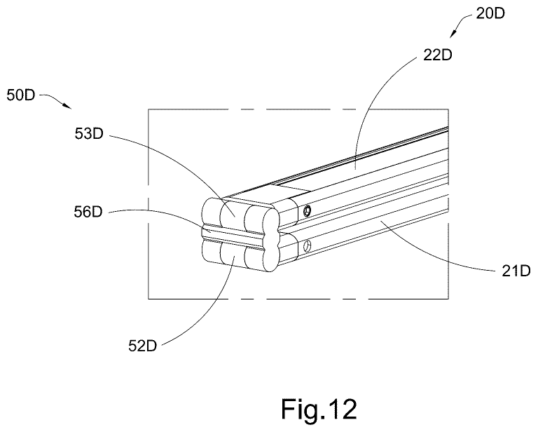

Referring to FIG. 12, a rotary folding lamp according to a fifth preferred embodiment of the present invention is shown. In this embodiment, modification is applied to the light emitting assembly 20D and the folding assembly 50D provided between the light emitting assembly 20D.

In this embodiment, the light emitting assembly 20D comprises a first light emitting part 21D and a second light emitting part 22D, and the folding assembly 50D comprises a second folding element 52D, a third folding element 53D, and a folding connecting element 56D. The folding connecting element 56D is connected between the second folding element 52D and the third folding element 53D, and the second folding element 52D and the third folding element 53D can rotate around the folding connecting element 56D.

The second folding element 52D is connected to a head end of the first light emitting part 21D, and the third folding element 53D is connected to a tail end of the second light emitting part 22D, so that the second light emitting part 22D can rotate 360° through the second folding element 52D, the third folding element 53D, and the folding connecting element 56D.

In other words, through the folding connecting element 56D, the second light emitting part 22D can be folded towards one side of the first light emitting part 21D, or towards the other side of the first light emitting part 21D. In the above embodiment, the two light emitting parts can only be folded in one direction, with a folding angle ranging from 0° to 180°, while in this embodiment, the two light emitting parts can be folded in both directions, with a folding angle ranging from 0° to 360°.

The second light emitting part 22D can be folded in two directions towards the first light emitting part 21D, making the folding process simpler. During storage, there is no need to consider the folding direction, making it more convenient for the user to use.

On the other hand, through the mutual cooperation of the second folding element 52D, the third folding element 53D, and the folding connecting element 56D, the second light emitting part 22D can be fixed at any folding angle, allowing for a larger adjustable angle range of illumination and meeting more user needs.

Therefore, in the present invention, the two emitting parts can be rotated and folded between each other, and the rotation and folding angles can be switched arbitrarily between 0°-360° according to the requirements, so that the rotating and folding lighting fixture has a larger illumination range and can meet the application requirements of various occasions.

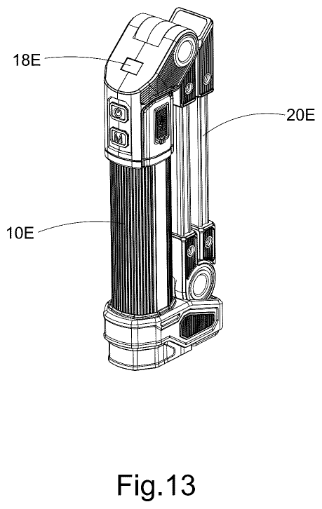

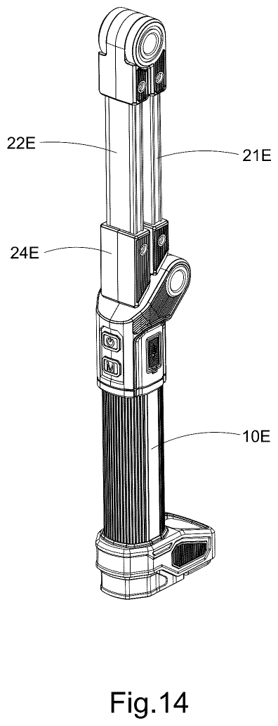

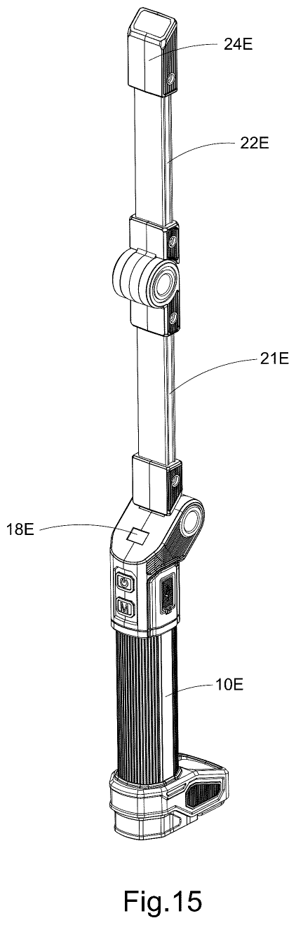

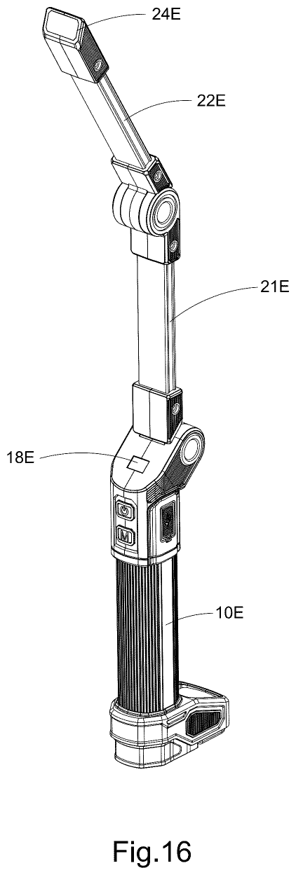

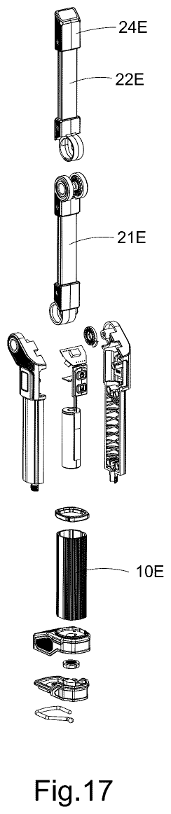

Referring to FIGS. 13 to 17 of the drawings, a rotary folding lamp according to a sixth preferred embodiment of the present invention is shown. In this embodiment, modification is applied to the light emitting assembly 20E which is mounted on the support assembly 10E. The light emitting assembly 20E comprises a first light emitting part 21E, a second light emitting part 22E and an end light emitting part 24E mounted to an end of the second light emitting part 22E. The position of the above third light emitting part 23 is replaced by a display screen 18E.

The end light emitting part 24E can be any type of light module, such as flash light. The display screen 18E can provide an illumination and also can display real-time operational data including power level, lighting parameters such as brightness level, color and temperature, and other information such as time and date. The display screen 18E also may be a touch screen for user input, so as to control the operation of the light emitting assembly 20E.

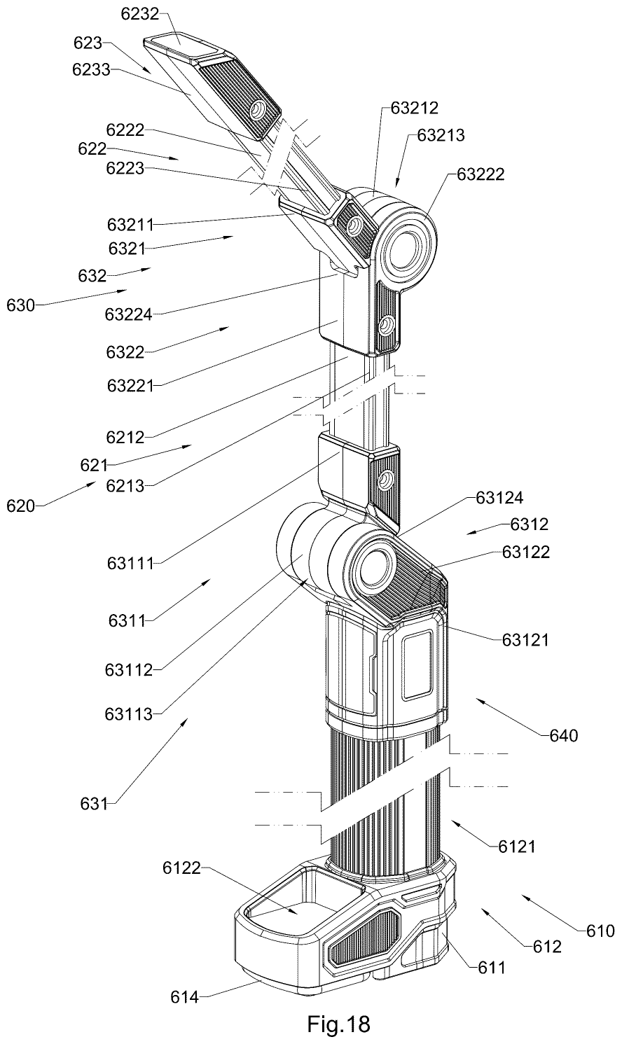

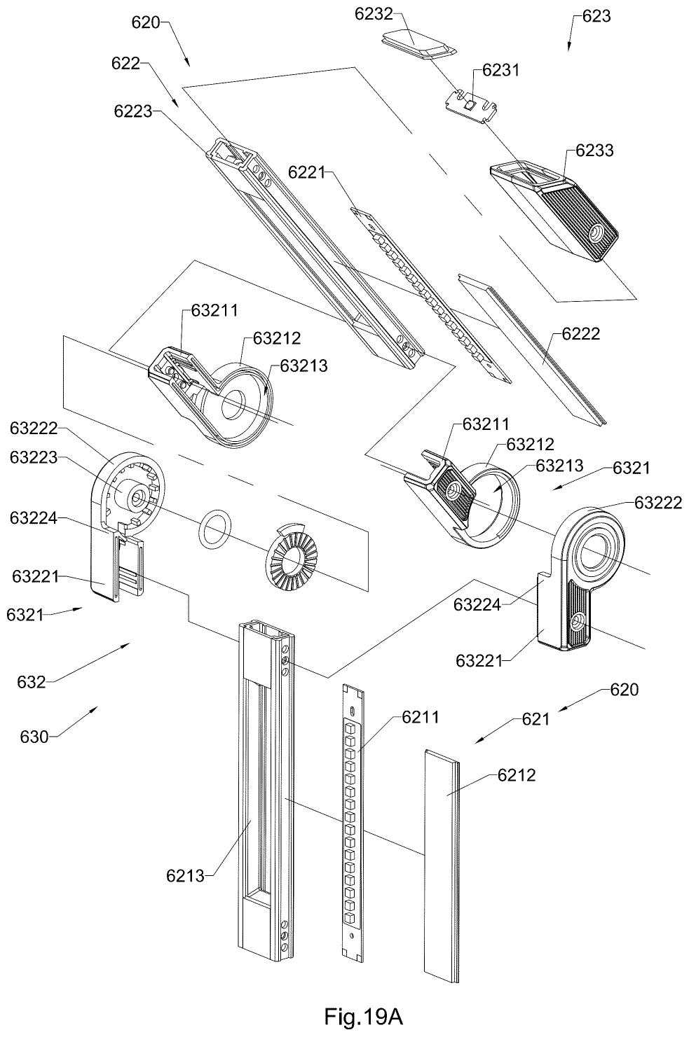

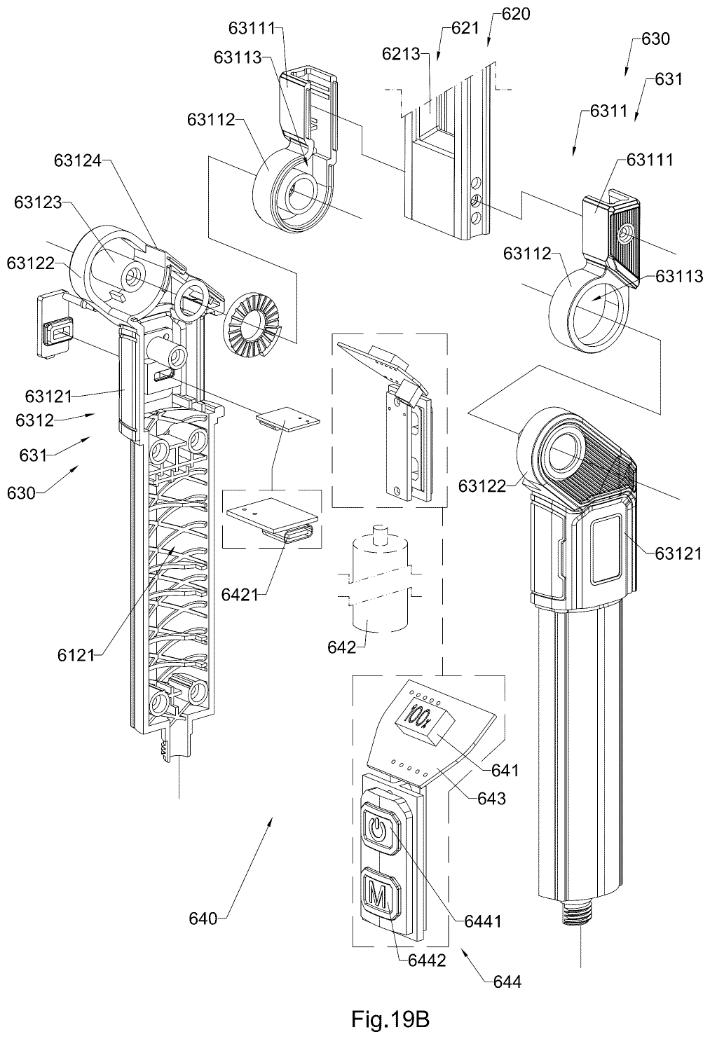

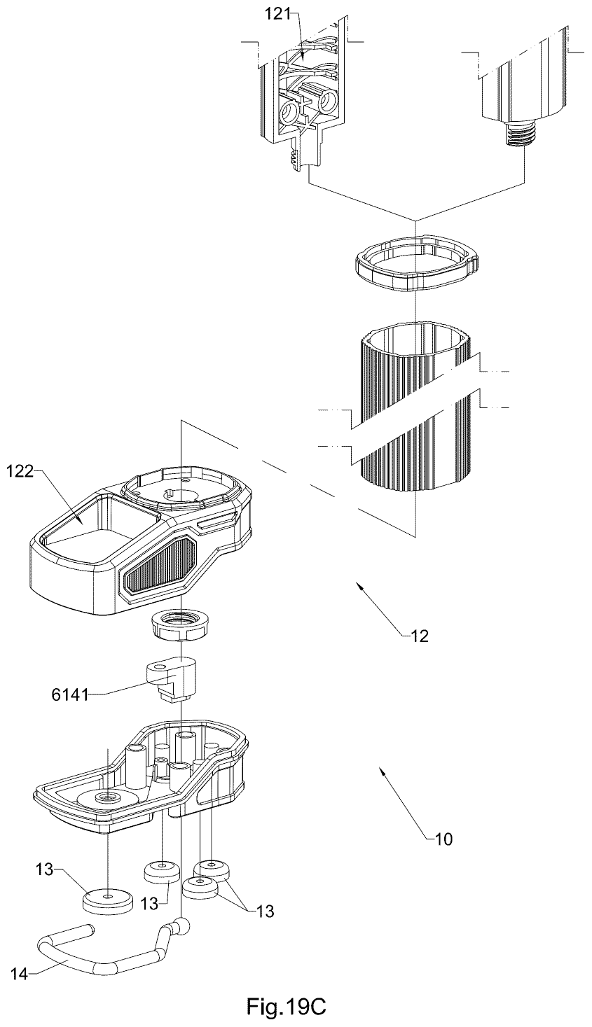

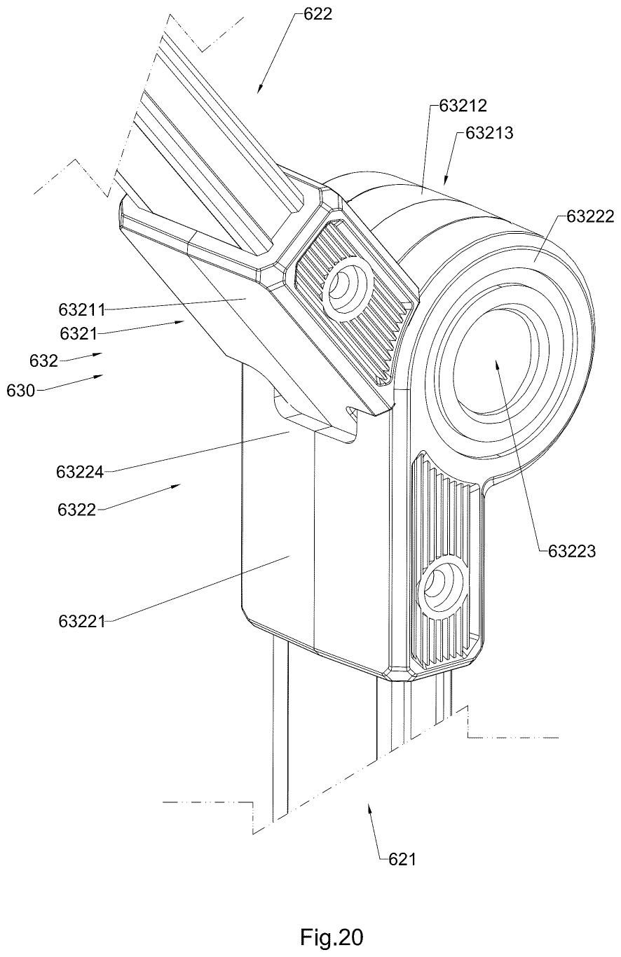

Referring to FIGS. 18 to 25 of the drawings, a multi-directional lighting fixture according to a seventh preferred embodiment of the present invention is illustrated. The multi-directional lighting fixture can realize multi-directional lighting, has a large lighting range, and is suitable for a variety of occasions. In this embodiment, the multi-directional lighting fixture comprises a base assembly 610, a lamp assembly 620, a folding mechanism 630 and a control unit 640, wherein the lamp assembly 620 is installed at the front end of the base assembly 610, the control unit 640 is arranged on the base assembly 610 and is used to control the lamp assembly 620, and the folding mechanism 630 is arranged on the lamp assembly 620 to realize the folding of the lamp assembly 620 itself and the folding relative to the base assembly 610.

In the embodiment of the present application, the lamp assembly 620 comprises a first lamp body 621, a second lamp body 622 and a third lamp body 623, the first lamp body 621 is installed at the front end of the base assembly 610, the second lamp body 622 is installed at the front end of the first lamp body 621, and the third lamp body 623 is arranged at the front end of the second lamp body 622, that is, the first lamp body 621 is connected between the base assembly 610 and the second lamp body 622, and the third lamp body 623 is arranged at the front end of the second lamp body 622. A variety of light-emitting modes can be combined between the first lamp body 621, the second lamp body 622 and the third lamp body 623, and different light-emitting modes can be activated according to the different folding and unfolding states, which can meet the various application requirements of different users.

It is worth mentioning that in the present embodiment, the first lamp body 621 and the second lamp body 622 are set to a long strip shape, and the first lamp body 621 and the second lamp body 622 can also be set to other shapes, which are not limited by the present embodiment.

It is worth mentioning that, in this embodiment, the first lamp body 621 and the second lamp body 622 can be folded by the folding mechanism 630, and the first lamp body 621 and the base assembly 610 can also be folded by the folding mechanism 630. It can be understood by those skilled in the art that the lamp assembly 620 can also be folded more times by setting more lamp bodies to meet more needs under the condition of stability.

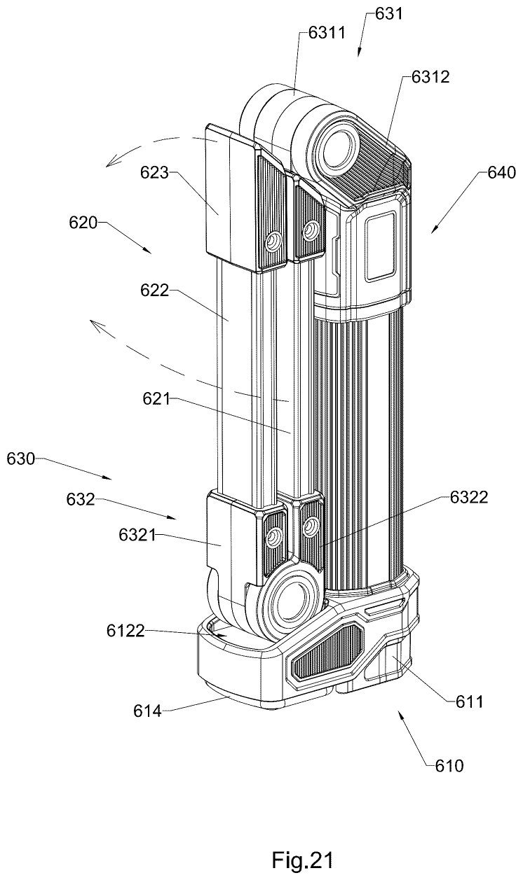

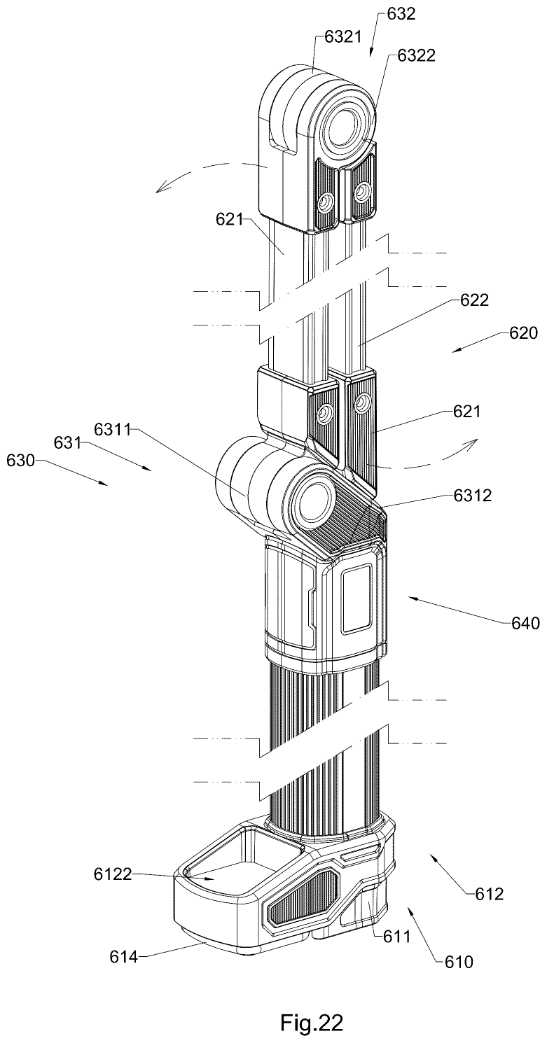

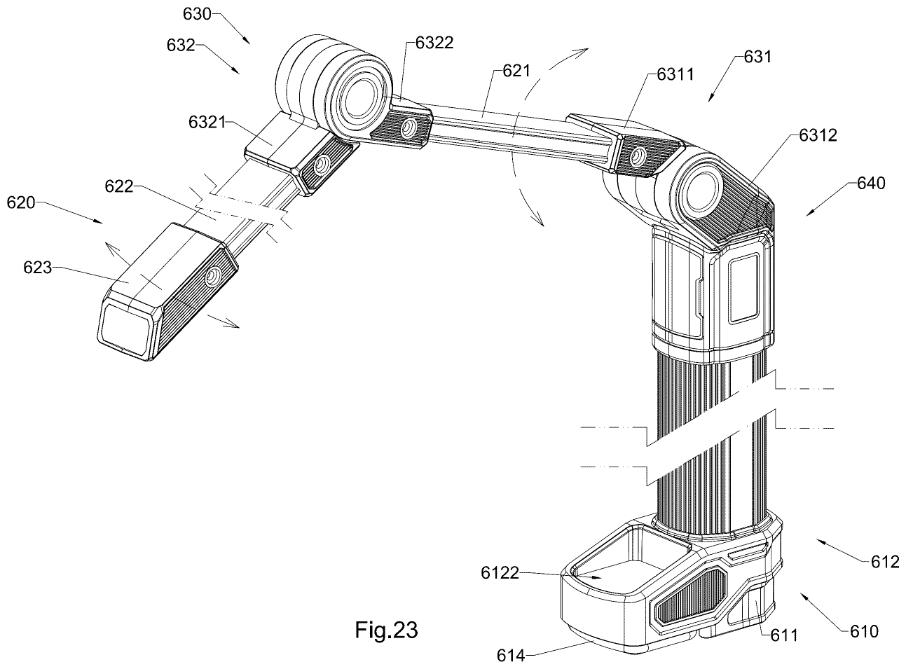

Specifically, in the embodiment of the present application, the first lamp body 621 and the second lamp body 622 have an unfolded state and a closed state. FIG. 21 is a view of the first lamp body 621 and the second lamp body 621 of the multi-directional lighting fixture according to this embodiment of the present invention in a closed state. When the first lamp body 621 and the second lamp body 622 are in a closed state, the base assembly 610, the first lamp body 621 and the second lamp body 622 are folded twice by the folding mechanism 630 to reduce the volume. FIG. 22 is a schematic view of the multi-directional lighting fixture according to the above embodiment of the present invention, in which the first lamp body 621 is in an unfolded state and the second lamp body 622 is in a closed state. The base assembly 610 and the first lamp body 621 are unfolded at a predetermined angle, and the first lamp body 621 and the second lamp body 622 are attached to each other. FIG. 23 is a schematic view of the multi-directional lighting fixture according to this embodiment of the present invention, in which the first lamp body 621 and the second lamp body 622 are both in an unfolded state. When the first lamp body 621 and the second lamp body 622 are both in an unfolded state, the base assembly 610, the first lamp body 621 and the second lamp body 622 are each unfolded at a predetermined angle, and can be fixed at any angle, which can meet the various application requirements of different users.

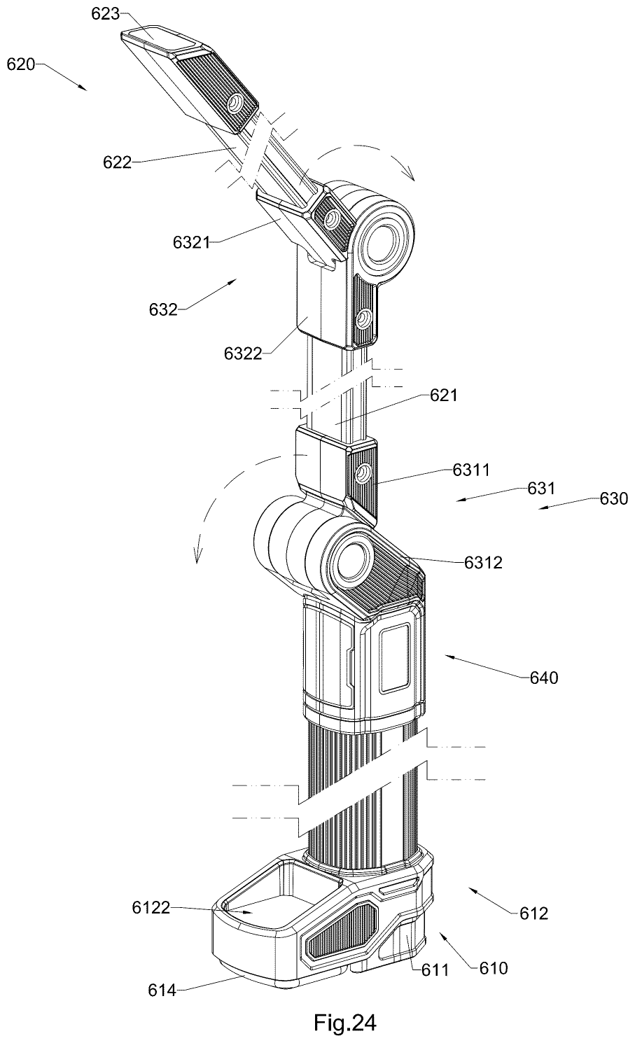

More specifically, as shown in FIG. 24 which is a schematic view of a maximum unfolded state of the multi-directional lighting fixture, in which the first lamp body 621 is suitable for folding from the base assembly 610 at a maximum angle of 180°, and the second lamp body 622 is suitable for folding from the first lamp body 621 at a maximum angle of 225°. When the multi-directional lighting fixture is in the unfolded state, multi-directional lighting can be realized, with a large lighting range, and is suitable for a variety of occasions. Continuing as shown in FIG. 21, when the first lamp body 621 and the second lamp body 622 are both in the closed state, the second lamp body 622 and the third lamp body 623 can be turned on by the control unit 640, so that the second lamp body illuminates toward the front and the third lamp body 623 illuminates upward. As shown in FIG. 22, when the first lamp body 621 is in the unfolded state and the second lamp body 622 is in the closed state, as the unfolding angle of the first lamp body 621 changes, the first lamp body 621 illuminates toward the front side, and the second lamp body 622 illuminates toward the rear side opposite to the first lamp body 621. As shown in FIG. 23 and FIG. 24, when the first lamp body 621 and the second lamp body 622 are both in the unfolded state and unfolded toward the maximum unfolded state, the first lamp body 621, the second lamp body 622 and the third lamp body 623 are suitable for illuminating toward three different directions.

The first lamp body 621 comprises a first light-emitting element 6211, a first lamp board 6212 and a first lamp body mounting portion 6213, and the second lamp body 622 comprises a second light-emitting element 6221, a second lamp board 6222 and a second lamp body mounting portion 6223, wherein the first lamp board 6212 is mounted on one side of the first lamp body mounting portion 6213, the first light-emitting element 6211 is mounted in the first lamp body mounting portion 6213 and emits light toward the first lamp board 6212, and the first lamp board 6212 is configured to be transparent so that the light emitted by the first light-emitting element 6211 can pass through the first lamp board 6212. The second lamp board 6222 is mounted on one side of the second lamp body mounting portion 6223, the second light-emitting element 6221 is mounted in the second lamp body mounting portion 6223 and emits light toward the second lamp board 6222, and the second lamp board 6222 is configured to be transparent so that the light emitted by the second light-emitting element 6221 can pass through the second lamp board 6222.

The first lamp body mounting portion 6213 and the base assembly 610 are connected in a foldable manner via the folding mechanism 630, and the first lamp body mounting portion 6213 and the second lamp body mounting portion 6223 are also connected in a foldable manner via the folding mechanism 630.

The third lamp body 623 comprises a third light-emitting element 6231, a third lamp board 6232 and a third lamp body mounting portion 6233. The third lamp body mounting portion 6233 is connected to the upper end of the second lamp body mounting portion 6223. The third lamp board 6232 is mounted on one side of the third lamp body mounting portion 6233. The third light-emitting element 6231 is mounted in the third lamp body mounting portion 6233 and faces the third lamp board 6232. The third lamp board 6232 is set to be transparent so that the light emitted by the third light-emitting element 6231 can pass through the third lamp board 6232.

In this embodiment, the third lamp body 623 is installed above the second lamp body 622, that is, the third lamp body 623 and the second lamp body 622 are suitable for lighting in different directions, that is, the third lamp body 623 is suitable for lighting in a longitudinal direction, and the second lamp body 622 and the first lamp body 621 are suitable for lighting in a transverse direction. Based on this, the multi-directional lighting fixture can achieve longitudinal and transverse lighting, and the lighting range is large. And the third lamp body 623 is located above the second lamp body 622, that is, located at the front of the multi-directional lighting fixture. When the third lamp body 623 is lighting, it will not be blocked by the front object, causing blurred lighting, so that the lighting is clearer.

It is worth mentioning that, in other possible implementations, the first lamp boards 6212 can be installed on both sides of the first lamp body mounting portion 6213, and the first light-emitting elements 6211 are respectively installed on both sides of the first lamp body mounting portion 6213 to provide multi-directional lighting; similarly, the second lamp boards 6222 can be installed on both sides of the second lamp body mounting portion 6223, and the second light-emitting elements 6221 are respectively installed on both sides of the second lamp body mounting portion 6223 to provide multi-directional lighting. This is not a limitation of the present invention.

The control unit 640 comprises a display screen 641, which is disposed on the base assembly 610. The display screen 641 can display information such as power, lighting mode, and folding angle in real time to achieve a smarter and more convenient interactive experience. Specifically, the power information is presented in the form of intuitive percentage numbers and dynamic power icons. Users can keep track of the remaining power of the multi-directional lighting fixture at any time to avoid sudden power outages that affect use. For example, when camping outdoors, they can know in advance whether they need to charge in time; the lighting mode will clearly mark the current different modes such as strong light, weak light, and flashing warning, so that users can quickly switch according to actual needs. For example, switching to weak light mode when walking at night can avoid the glare of strong light, and switching to flashing warning mode in an emergency can serve as a call for help; the folding angle information uses precise digital real-time feedback on the angle between the first lamp body 621 and the base assembly 610, and the second lamp body 622 and the first lamp body 621, to help users accurately control the unfolded state of the multi-directional lighting fixture and ensure that the lighting angle meets expectations. For example, when performing precision maintenance work, the most suitable lighting angle can be adjusted according to the displayed angle data.

The control unit 640 further comprises a power supply 642, a control circuit 643 and a control interface 644. The power supply 642 and the control circuit 643 are installed in the base assembly 610. The control interface 644 is installed on the surface of the base assembly 610 and is electrically connected to the power supply 642 and the first lamp body 621, the second lamp body 622 and the third lamp body 623. The user controls the lighting and angle adjustment of the lamp assembly 620 by opening and closing the control interface 644. The control circuit 643 is electrically connected to the first lamp body 621, the second lamp body 622, the third lamp body 623, the power supply 642 and the control interface 644. By operating the control interface 644, an electrical signal is sent to the circuit module 633, and then the user controls the lighting and angle adjustment of the lamp assembly 620 by the control interface 644.

The control unit 640 is also provided with an electrical interface 6421, which is located on the base assembly 610. The power supply is connected through the electrical interface 6421 to charge the power supply 642 to provide power to the lamp assembly 620.

Preferably, the control interface 644 comprises a switch control component 6441 and a lamp body control component 6442. The switch control component 6441 is used to control whether the lamp assembly 620 emits light or not, and the lamp body control component 6442 is used to control the angle adjustment of the lamp assembly 620. The control component 644 can also be provided with buttons with other functions, which is not limited.

The base assembly 610 comprises a base 611 and a support part 612. The support part 612 is connected to the top of the base 611. The support part 612 and the first lamp body mounting part 6213 are foldably connected through the folding mechanism 630. The support part 612 has an anti-slip function, which makes it more secure when the user holds it. The support portion 612 can be made of anti-skid material, or can be made anti-skid by providing rounded anti-skid protrusions and grooves on the surface, which is not a limitation of the present invention.

The support portion 612 has an inner cavity 6121 and an outer cavity 6122, wherein the inner cavity 6121 is located inside the support portion 612, and the outer cavity 6122 extends inward from one side of the support portion 612. After the first lamp body 621 and the second lamp body 622 are folded by the folding mechanism 630, they are suitable for being stored in the outer cavity 6122. The power supply 642 and the control circuit 643 are installed in the inner cavity 6121.

The base assembly 610 also comprises a first mounting component 613 and a second mounting component 614, and the first mounting component 613 and the second mounting component 614 are both arranged at the bottom of the base 611. In this embodiment, the first mounting component 613 is implemented as a magnetic suction component, and the second mounting component 614 is implemented as a hook, and the hook is provided with a silicon member 6141 for installation. Through the first mounting component 613 and the second mounting component 614, the multi-directional lighting fixture can be fixed by magnetic suction or suspension.

The folding mechanism 630 comprises a first folding component 631 and a second folding component 632. The first folding component 631 is arranged between the supporting portion 612 of the base assembly 610 and the first lamp body 621, and the second folding component 632 is arranged between the first lamp body 621 and the second lamp body 622. That is to say, the supporting portion 612 and the first lamp body 621 are foldably connected via the first folding component 631, and the first lamp body 621 and the second lamp body 622 are foldably connected via the second folding component 632.

The first folding component 631 comprises a first folding portion 6311 and a first fixing portion 6312, wherein the first fixing portion 6312 is connected to the upper portion of the support portion 612 of the base assembly 610, and the first folding portion 6311 is disposed at the lower end of the first lamp body 621, and the first folding portion 6311 is suitable for folding around the first fixing portion 6312, thereby realizing the folding of the first lamp body 621 around the support portion 612 of the base assembly 610.

Specifically, the first folding portion 6311 comprises a first connecting member 63111, a first folding member 63112, and a first rotating cavity 63113, wherein the first connecting member 63111 is connected to the lower end of the first lamp body 621, and the first rotating cavity 63113 is disposed at the first folding member 63112, and the first folding member 63112 extends from the first connecting member 63111 to be foldably connected to the first fixing portion 6312. The first fixed portion 6312 comprises a first fixed member 63121, a first extension member 63122, a first rotating member 63123 and a first limiting member 63124. The first fixed member 63121 is connected to the top of the supporting portion 612. The first extension member 63122 extends from the surface of the first fixed member 63121 at a predetermined angle, preferably 45°. The first rotating member 63123 is arranged on the first extension member 63122 and is suitable for rotating within the first rotating cavity 63113 of the first folding portion 6311, thereby realizing that the first folding portion 6311 is suitable for folding around the first fixed portion 6312. The first stopper 63124 is disposed on the first extension member 63122. When the first folding portion 6311 is folded to the maximum extent around the first fixing portion 6312, the first connecting member 63111 of the first folding portion 6311 is adapted to be engaged by the first stopper 63124, thereby making the first lamp body 621 in the maximum unfolded state, that is, the first folding portion 6311 is folded 180° around the first fixing portion 6312, that is, the first lamp body 621 is adapted to be folded 180° around the base assembly 610.

In this embodiment, the display screen 641 is preferably disposed on the surface of the first extension member 63122 of the first fixing portion 6312, and the first extension member 63122 extends from the surface of the first fixing portion 63121 at an angle of 45°, so that the user can more intuitively observe the content on the display screen 641.

The second folding component 632 comprises a second folding portion 6321 and a second fixing portion 6322, wherein the second fixing portion 6322 is connected to the top of the first lamp body 621, the second folding portion 6321 is disposed at the lower end of the second lamp body 622, and the second folding portion 6321 is suitable for folding around the second fixing portion 6322, thereby realizing the folding of the second lamp body 622 around the first lamp body 621.

Specifically, the second folding portion 6321 comprises a second connecting member 63211, a second folding member 63212 and a second rotating cavity 63213, wherein the second connecting member 63211 is connected to the lower end of the second lamp body 622, the second rotating cavity 63213 is disposed at the second folding member 63212, and the second folding member 63212 is extended from the second connecting member 63211 to be foldably connected to the second fixing portion 6322. The second fixed portion 6322 comprises a second fixed member 63221, a second extension member 63222, a second rotating member 63223 and a second limiting member 63224. The second fixed member 63221 is connected to the top of the first lamp body 621. The second extension member 63222 is extended from the surface of the second fixed member 63221. The second rotating member 63223 is arranged on the second extension member 63222 and is suitable for rotating within the second rotating cavity 63213 of the second folding portion 6321, thereby realizing that the second folding portion 6321 is suitable for folding around the second fixed portion 6322. The second stopper 63224 is disposed on the second fixing member 63221, and when the second folding portion 6321 is folded to the maximum extent around the second fixing portion 6322, the second connecting member 63211 of the second folding portion 6321 is adapted to be engaged by the second stopper 63224, thereby making the second lamp body 622 in the maximum unfolded state, that is, the second folding portion 6321 is folded 225° around the second fixing portion 6322. That is, the second lamp body 622 is adapted to be folded 225° around the first lamp body 621.

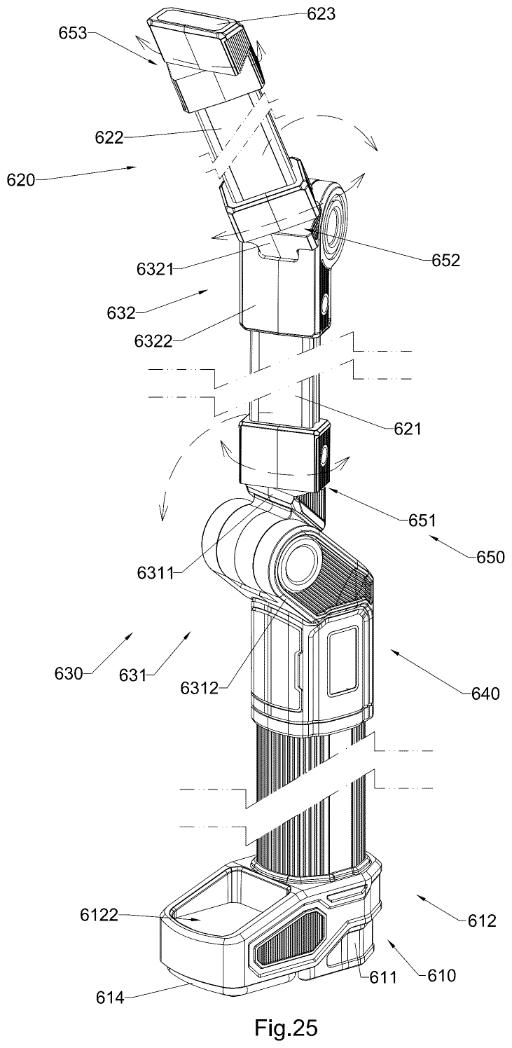

As shown in FIG. 25, the multi-directional lighting fixture further comprises a rotating mechanism 650, and the rotating mechanism 650 comprises a first rotating part 651, a second rotating part 652, and a third rotating part 653. The first rotating part 651 is disposed between the base body 610 and the first lamp body 621, the second rotating part 652 is disposed between the first lamp body 621 and the second lamp body 622, and the third rotating part 653 is disposed between the second lamp body 622 and the third lamp body 623. That is, the first lamp body 621 rotates on the base body 610 through the first rotating part 651, the second lamp body 622 rotates on the first lamp body 621 through the second rotating part 652, and the third lamp body 623 rotates on the second lamp body 622 through the third rotating part 653, thereby realizing multi-directional lighting of the multi-directional lighting fixture 61, with a large lighting range, and being suitable for various occasions. In other possible implementations, the number of the rotating mechanisms 650 can be changed. When different numbers of the lamp bodies are provided, the number of the rotating mechanisms 650 is also changed, which is not a limitation of the present invention.

Preferably, the first rotating part 651 is provided at the first connecting member 63111 of the first folding portion 6311, the second rotating part 652 is provided at the second connecting member 63211 of the second folding portion 6321, and the third rotating part 653 is provided at the third lamp body mounting portion 6233 of the third lamp body 623. The positions of the first rotating part 651, the second rotating part 652 and the third rotating part 653 are not limitations of the present invention.

In summary, the multi-directional lighting fixture can realize multi-directional lighting, has a large lighting range, and is suitable for a variety of occasions. The multi-directional lighting fixture is provided with a plurality of lamp bodies, and the plurality of lamp bodies can be rotated and folded, and can be fixed to any angle, and the angle control range is larger.

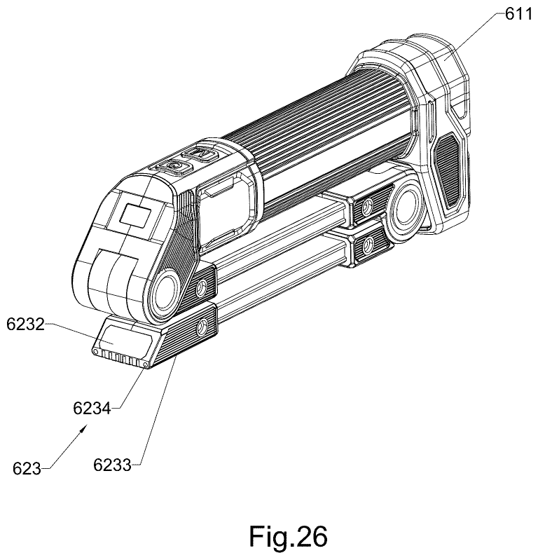

As shown FIG. 26, one or more magnetic elements 6234 such as magnets are provided on an end of the third lamp body mounting portion 6233. By folding or bending the first lamp body 621 and a second lamp body 622, the position of the magnetic elements 6234 can be adjusted, thereby enabling the magnetic elements 6234 to retrieve small objects such as screws from spaces that are inaccessible by hand.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention comprises all modifications encompassed within the spirit and scope of the following claims.

What is claimed is:

1. A rotary folding lamp, comprising:
a support assembly, wherein the support assembly comprises an installation housing having an installation cavity provided at an interior of the installation housing and a storage cavity indented from one side of the installation housing at an exterior thereof, wherein the storage cavity is formed between a top end and a bottom end of the installation housing;
a light emitting assembly, wherein the light emitting assembly comprises a first light emitting part and a second light emitting part which is foldably connected to the first light emitting part, wherein each of the first light emitting part and the second light emitting part has a first end and an opposed second end, wherein the light emitting assembly further comprises an end light emitting part mounted to an upper end of the second light emitting part;
a rotation assembly arranged between the first end of the first light emitting part and the top end of the support assembly to allow the first light emitting part to rotate self-rotate with respect to the support assembly;
a folding assembly arranged between the top end of the support assembly and the rotation assembly to allow the first light emitting part to be folded onto the support assembly; and
a control component arranged on the support assembly and electrically connected to the light emitting assembly.

2. The rotary folding lamp according to claim 1, wherein the folding assembly comprises:
a first folding element rotatably coupled between the top end of the installation housing and the first end of the first light emitting part to allow the light emitting assembly being rotatably folded in-and-out the storage cavity; and
a folding joint provided between the second end of the first light emitting part and the first end of the second light emitting part, such that the first light emitting part and the second light emitting part are adapted to fold and overlap with each other via the rotation joint in order to rotatably fold into the storage cavity via the first folding element, wherein the rotation assembly comprises a first rotating element extended from the first folding element of the folding assembly and a second rotating element coupled at the first end of the first light emitting part, wherein the first rotating element is rotatably coupled with the second rotating element, such that the second rotating element is not only rotated 360° around the first rotating element but also pivotally rotated at the first folding element so as to allow the light assembly to be self-rotated and pivotally folded at a desired angle at the top end of the installation housing.

3. The rotary folding lamp according to claim 2, wherein the end light emitting part is a flash light.

4. The rotary folding lamp according to claim 2, further comprising a display screen on the support assembly.

5. A multi-directional lighting fixture, comprising:
a base assembly;
a folding mechanism;
a control unit; and
a lamp assembly comprising a first lamp body, a second lamp body and a third lamp body, wherein the first lamp body is connected between the base assembly and the second lamp body, the third lamp body is arranged at a front end of the second lamp body, the folding mechanism is arranged at both ends of the first lamp body to control folding of the first lamp body and the second lamp body, and the control unit is electrically connected to the lamp assembly.

6. The multi-directional lighting fixture according to claim 5, wherein the control unit comprises a display screen, and the display screen is arranged on the base assembly.

7. The multi-directional lighting fixture according to claim 5, wherein the folding mechanism comprises a first folding component and a second folding component, the first folding component is arranged between the base assembly and the first lamp body, and the second folding component is arranged between the first lamp body and the second lamp body.

8. The multi-directional lighting fixture according to claim 7, wherein the first lamp body is arranged for being folded around the base assembly by 0° to 180°, and the second lamp body is arranged for being folded around the first lamp body by 0° to 225°.

9. The multi-directional lighting fixture according to claim 8, wherein the first lamp body comprises a first light-emitting element, a first lamp board and a first lamp body mounting portion, the first lamp board is mounted on a side of the first lamp body mounting portion, the first light-emitting element is mounted in the first lamp body mounting portion and emits light toward the first lamp board.

10. The multi-directional lighting fixture according to claim 9, wherein the second lamp body comprises a second light-emitting element, a second lamp board and a second lamp body mounting portion, the second lamp board is mounted on one side of the second lamp body mounting portion, the second light-emitting element is mounted in the second lamp body mounting portion and emits light toward the second lamp board.

11. The multi-directional lighting fixture according to claim 10, wherein the third lamp body comprises a third light-emitting element, a third lamp board and a third lamp body mounting portion, the third lamp body mounting portion is connected to an upper end of the second lamp body mounting portion, the third light board is mounted on a side of the third lamp body mounting portion, and the third light-emitting element is mounted in the third lamp body mounting portion and faces the third light board.

12. The multi-directional lighting fixture according to claim 11, wherein the control unit further comprises a power supply, a control circuit and a control interface, the power supply and the control circuit are installed in the base assembly, and the control interface is installed on a surface of the base assembly and electrically connected to the power supply, the control circuit and the lamp assembly.

13. The multi-directional lighting fixture according to claim 12, wherein the base assembly comprises a base and a support part, the supporting part is connected to a top of the base, the supporting part has an inner cavity and an outer cavity, wherein the inner cavity is located inside the supporting part to install the power supply and the control circuit, and the outer cavity extends inwardly from a side of the supporting part to accommodate the first lamp body and the second lamp body.

14. The multi-directional lighting fixture according to claim 13, wherein the base assembly further comprises a first mounting component and a second mounting component, and the first mounting component and the second mounting component are both arranged at a bottom of the base.

15. The multi-directional lighting fixture according to claim 7, wherein the first folding component comprises a first folding portion and a first fixing portion, the first fixing portion is connected to the top of the support part of the base assembly, the first folding portion is arranged at a lower end of the first lamp body, and the first folding portion is arranged for folding around the first fixing portion to control the first lamp body to fold around the supporting part of the base assembly.

16. The multi-directional lighting fixture according to claim 15, wherein the first folding portion comprises a first connecting member, a first folding member and a first rotating cavity, the first connecting member is connected to the lower end of the first lamp body, the first rotating cavity is arranged on the first folding member, the first folding member is extended from the first connecting member to be foldably connected to the first fixing portion, the first fixing portion comprises a first fixed member, a first extension member, a first rotating member and a first limiting member, the first fixed member is connected to the top of the supporting part, the first extension member is extended at a predetermined angle from a surface of the first fixed member, the first rotating member is arranged on the first extension member and is arranged for rotating from the first rotating cavity of the first folding part, and the first limiting member is arranged on the first extension member to limit a folding angle of the first folding portion.

17. The multi-directional lighting fixture according to claim 16, wherein the display screen is disposed on a surface of the first extension member of the first fixing portion.

18. The multi-directional lighting fixture according to claim 16, wherein the second folding component comprises a second folding portion and a second fixing portion, the second fixing portion is connected to a top of the first lamp body, the second folding portion is arranged at a lower end of the second lamp body, and the second folding portion is arranged for folding around the second fixing portion to control the second lamp body to fold around the first lamp body.

19. The multi-directional lighting fixture according to claim 18, wherein the second folding portion comprises a second connecting member, a second folding member and a second rotating cavity, the second connecting member is connected to the lower end of the second lamp body, the second rotating cavity is arranged on the second folding member, the second folding member is extended from the second connecting member to be foldably connected to the second fixed portion, the second fixed portion comprises a second fixed member, a second extension member, a second rotating member and a second limiting member, the second fixed member is connected to the top of the first lamp body, the second extending member is extended from the surface of the second fixed member, the second rotating member is arranged on the second extending member and is arranged for rotating from the second rotating cavity, and the second limiting member is arranged on the second fixed member to limit a folding angle of the second folding portion.

20. The multi-directional lighting fixture according to claim 19, further comprising a rotating mechanism, which comprises a first rotating part, a second rotating part and a third rotating part, the first rotating part is arranged between the base and the first lamp body, the second rotating part is arranged between the first lamp body and the second lamp body, and the third rotating part is arranged between the second lamp body and the third lamp body, rotation angles of the first rotating part, the second rotating part and the third rotating part are set to 0° to 360°.
